(19) United States
(12) Patent Application Publication
(10) Pub. No.: US 2006/0150245 A1
(43) Pub. Date: Jul. 6, 2006

(54) System and method of automatically transforming instant message transmission modes on internet

(75) Inventors: Hao-Wei Cheng, Tao-Yuan City (TW); Chao-Chun Lee, Taipei (TW); Chun-Nan Yu, Kaohsiung City (TW); Wen-Hao Hsu, Taipei (TW)

Correspondence Address: BIRCH STEWART KOLASCH & BIRCH, PO BOX 747, FALLS CHURCH, VA, 22040-0747, US

(73) Assignee: INFOPOWER CORPORATION

(21) Appl. No.: 11/158,043

(22) Filed: Jun. 22, 2005

(30) Foreign Application Priority Data
Dec. 31, 2004 (TW) 93141566

(51) Int. Cl. G06F 15/16; G06F 17/00; G06F 9/00; H04L 9/32; G06K 9/00; G06F 17/30; G06F 7/04; G06F 7/58; G06K 19/00; H04L 9/00

(52) U.S. Cl. 726/12; 726/4; 713/151

(57) ABSTRACT

A system and method of automatically transforming instant message transmission modes on the Internet is disclosed. The transformation system is applied to a Java-based instant messenger and could be automatically transformed to four transmission modes in accordance with different network environments. The four transmission modes include the socket mode (i.e. direct connection through socket), HTTP 1.1 mode (i.e. connection through a proxy server and a firewall that both support HTTP 1.1), HTTP 1.0 mode (i.e. connection through a proxy server and a firewall that both support HTTP 1.0) and a pure-HTML mode (i.e. without JAVA applet).

### BACKGROUND OF THE INVENTION

1. Field of the Invention

The present invention relates to an interactive instant message transmission system, in particular to a system and method of automatically transforming instant message transmission modes on the Internet.

2. Description of the Prior Art

With the rapid development of relevant Internet applications, the online instant message transmission system is not only convenient and fast, but also provides underlying functions to the users: to associate with other people, to learn about a user's current status, to chat with other users, and to play online games and holding a video conference with other people. Usually the online instant message transmission system includes two operational modes as follows: communication mode based on character streams and communication mode based on video/audio mixed data streams. In recent years, software for online instant message transmission becomes very popular, for example the well-known AOL, ICQ, MSN, Yahoo Messenger . . . etc. With online instant message software, a user may know the current status of friends, communicate with online friends in letters or voices, or even communicate with a friend via video.

However, for the aforementioned online instant message systems, the user has to download and install relevant software firstly, hence it leads to a little inconvenience to people. Moreover, foregoing software (i.e. MSN) has to pass through the client's proxy servers, such as Microsoft ISA server, CCProxy, Wingate, Winproxy, Squid, Netscape-proxy, CERN-HPPTD, Commerce-Builder, Apache, Microsoft proxy and IBM-Secure-Export-ICS, or to pass through firewalls such as Cisco, Netscreen and Checkpoint to establish an Internet connection. When clients tend to build up a connection with a proxy server, sometimes the login takes too much time (i.e. 20 sec) and are unable to pass through the proxy severs such as Wingate or Winproxy. Besides, there is also a web-based instant message transmission system, which has been proposed, in recent years. By the web-based system, a user needs only the web browser (i.e. Microsoft Internet Explorer) to provide an interactive message transmission platform. Hence it's unnecessary to worry about firewalls or proxy servers from blocking the transmitting packets. In contrast, the web-based system provides less function to users.

### SUMMARY OF THE INVENTION

According to the drawbacks in the prior arts, a platform for interactive message transmission and conference meeting that is unnecessary of installing an additional application but merely the web browser (i.e. Internet Explorer) and the Java run-time environment (JRE), thereby being adaptive to different transmission modes and connection ports at client, has been provided in the invention. Moreover, by utilizing sockets or HTTP packets to exchange data, the invention may transform its four operational modes in accordance with different proxy servers and different versions of HTTP protocols to achieve the best transmission performance.

An object of the invention is to provide a system and method of automatically transforming instant message transmission modes on the Internet, which is applied to the instant messenger constructed with a Java network platform and be capable of transforming the transmission modes thereof according to different network environments.

The aforementioned four transmission modes include mode 1 (socket mode, a client connects to the server directly through any allowable socket), mode 2 (HTTP 1.1 mode, a client connects to the server across the proxy servers and firewalls supporting HTTP 1.1), mode 3 (HTTP 1.0 mode, a client connects to the server across the proxy servers and firewalls supporting HTTP 1.0), and mode 4 (pure-HTML mode, no Java application is needed, in other words, a web-based instant message transmission system). Herein, the major difference between HTTP 1.1 and HTTP 1.0 is that HTTP 1.1 provides persistent connection and HTTP 1.0 provides non-persistent connection.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 illustrates the user interface of an embodiment instant message transmission system of the invention;

FIG. 2A illustrates the schematic diagram of an embodiment automatic transforming instant transmission mode system; and

FIG. 2B illustrates the flowchart of the embodiment automatic transforming instant transmission mode system.

### DETAILED DESCRIPTION OF THE INVENTION

Some preferred embodiments of the present invention will be described in detail in the following. However, beside the detailed description, the present invention can also be applied widely in other embodiments and the scope of the present invention is only limited by the appended claims. Moreover, some irrelevant details are not drawn in order to make the illustrations concise and to provide a clear description for easily understanding the present invention.

It's noticed that, firstly, although the present system of automatically transforming transmission modes is applied to a Java-based instant message transmission system in the embodiments of the invention, it is not only limited to the above-mentioned embodiment instant message transmission system but it also includes the electronic whiteboard and the network conference system.

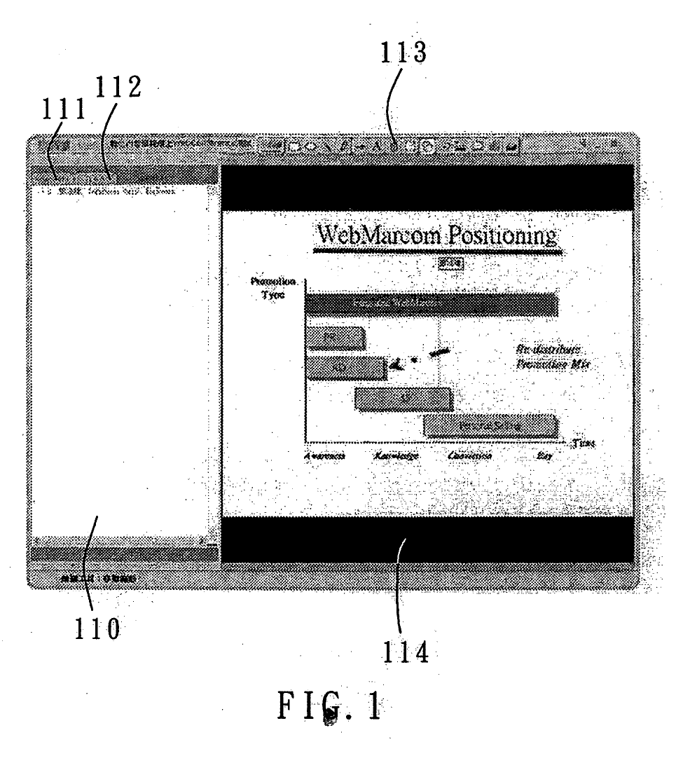

The aforementioned instant message transmission system may be distinguished into two categories, one is the instant message transmission system constructed by a web browser and Java run-time environment, which needs to download a Java plug-in before usage, and the another is the web-based instant message transmission system. The application programs at the server are usually coded in a Java applet or Java scripts, and the user interfaces of web-based system are totally represented in HTML, hence the user could transfer/receive instant messages as long as having a web browser. FIG. 1 depicts the user interface of an instant message transmission system with an embodiment of the invention, wherein block 110 is the instant interactive area, and a user may see all online users in attendees 111 and transmit instant messages through Q&A 112. Toolbar 113 includes “Graphic tool”, briefcase and instant questionnaire toolbar, the user may highlight sentences for immediate discussion, and upload the composite documents (includes: Microsoft word, Microsoft excel, Microsoft power point and general image files), or use instant questionnaire toolbar to edit and issue questionnaires. Electronic whiteboard 114 is a block used to display foregoing composite documents, and the user may highlight sentences on the electronic whiteboard 114 by using the graphic tool of toolbar 113.

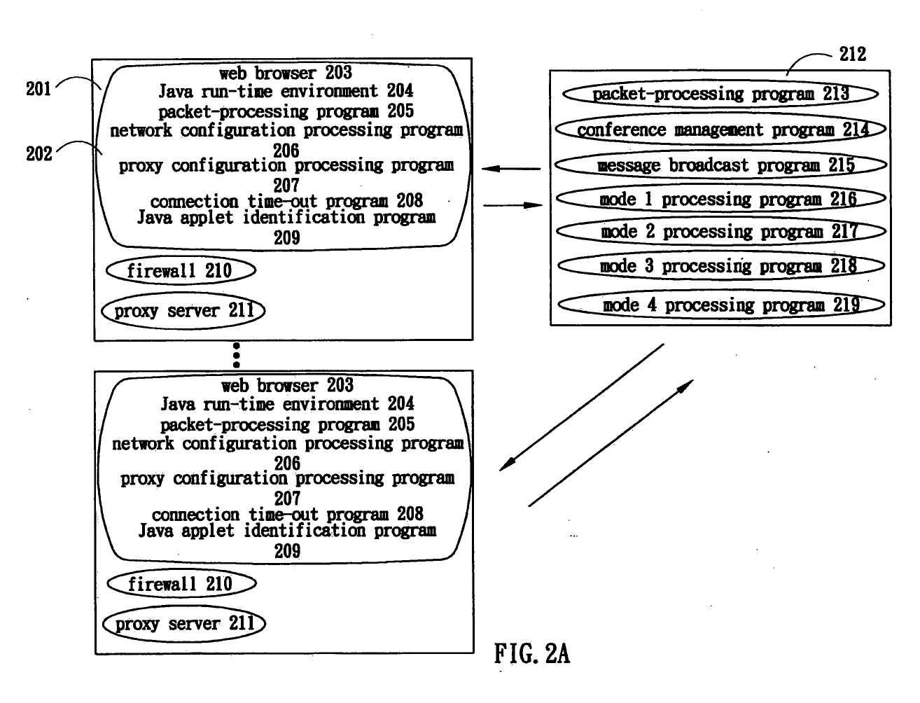

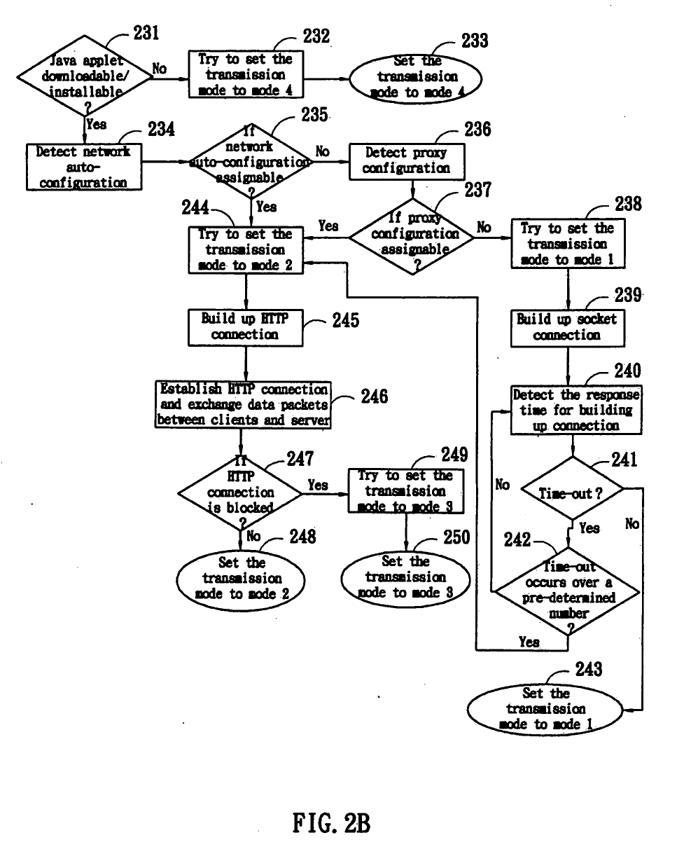

FIG. 2A is the brief diagram of an instant message transmission system for automatically transforming the transmission modes, wherein block 212 represents at least two clients and block 212 represents the server. Block 201 (client) includes a computer system 202, a firewall 210 and a proxy server 211. The computer system 202 further comprises a web browser 203, which contains a network auto-configuration and a proxy configuration therein; a Java run-time environment 204; a packet-processing program 205 for processing the transmitting packets between clients 201 and the server 212; a network configuration processing program 206 for detecting and identifying the network auto-configuration; a proxy configuration processing program 207 for detecting and identifying the proxy configuration; a connection time-out program 208 and a Java applet identification program 209 for identifying if the client 201 is allowable to download and install a Java applet. Besides, the server 212 comprises: a packet-processing program 213 for processing the transmitting packets between the server 212 and the clients 201; a conference management program 214 for opening/closing a network conference and managing the login/logout of the client 201; a message broadcast program 215 for transmitting the messages to individual client 201 and broadcasting messages to all the clients 201 participating in the network conference; a mode 1 processing program 216 for processing the network connection mechanism of mode 1 and decoding the packets of mode 1; a mode 2 processing program 217 for processing the network connection mechanism of mode 2 and decoding the packets of mode 2; a mode 3 processing program 218 for processing the network connection mechanism of mode 3 and decoding the packets of mode 3; and a mode 14 processing program 219 for processing the network connection mechanism of mode 4 and decoding the packets of mode 4.

It should be understood that, the above-mentioned packet-processing program is a multi-threading Java application, which temporary stores all received packets in queue, and raises up the server's performance and speeds up the packet-processing time with multi-threading process, and it also provides different instant message processing mechanism with different transmission modes of clients. Furthermore, the aforementioned four transmission modes include mode 1 (socket mode, a user connects to the server directly through any allowable socket), mode 2 (HTTP 1.1 mode, a user passes the proxy servers and firewalls supporting HTTP 1.1 through to connect to the server), mode 3 (HTTP 1.0 mode, a user passes the proxy servers and firewalls supporting HTTP 1.0 through to connect to the server), and mode 4 (pure-HTML mode, no Java application is needed, in other words, a web-based instant message transmission system). Herein, the major difference between HTTP 1.1 and HTTP 1.0 is that HTTP 1.1 provides persistent connection. Besides, referring to FIG. 2A, when the transmission mode belongs to mode 1 to mode 3, the client needs only the web browser and Java run-time environment; when the transmission mode belongs to mode 4, the client needs only the web browser but not the Java run-time environment.

Among the four transmission modes, mode 1 is applied to the most unrestricted and mode 4 is applied to the most restrictive network environment. When the network environment allows the client to connect to the server within any free sockets, the client tends to adopt mode 1 as its transmission mode. When the sockets are restrictive but the network environment allows the user to establish HTTP 1.1 connection, the client tends to adopt mode 2 to connect to the server. Mode 3 is applied to the network environment that the socket connection is unallowable, HTTP 1.1 connection is unsupported but HTTP 1.0 connection is supported. And mode 4 is applied to the network environment merely supporting HTML. So, less network environments the mode with higher priority (less number) may be applied to. For example, the network environment that mode 1 may operate normally, mode 2-4 operates normally, too. The network environment that mode 2 operates normally, mode 3 and mode 4 also operate normally but nor the mode 1. Though mode 4 connection may be executed in the network environment that also the mode 1 connection may operate, the client always prefers the high priority transmission mode (in the order of 1>2>3>4) to build up connection with the server.

FIG. 2 depicts the flowchart of the embodiment automatically transforming the instant transmission mode system, and the underlying paragraph illustrates the procedure of the automatic transforming transmission modes. Firstly, step 231 identifies if the computer of the client allows the downloading and installation of a Java applet? If the answer is negative, the procedure will try to set the transmission mode to mode 4 (step 232), and then the transmission mode is set to mode 4 (step 233). Otherwise, the proceeding step 234 if the computer of the client allows the downloading and installation of a Java applet. That is, the invention detects the network auto-configuration of the web browser (i.e., Internet Explorer) to determine adopting mode 1 or mode 2 according to whether the net work auto-configuration of the web browser is assignable or not (step 235). If the network auto-configuration is not assignable, proceed to step 236 to detect the proxy configuration of web browser. Next, identify whether the proxy server is assignable in step 237. If negative, try to set the transmission mode to mode 1 (step 238) and build up a direct connection to the server through the socket (step 239). When the client logins with mode 1, the client will start a connection time-out program to detect the response time of the connection (step 240). Step 241 identifies if the response time exceeds the general response time of common servers—connection time-out (i.e. 1 to 3 seconds). If negative, set the transmission mode to mode 1 (step 243). If positive, proceed step 242 to identify if the response time exceeds a pre-defined number. Usually the pre-defined number is 3, and if time-out occurs less than 3 times, the procedure returns to step 240. If there are more than 3 time-out occur, the procedure will try to set the transmission mode to mode 2 (step 244).

If the aforementioned network auto-configuration is assignable, the procedure advances to step 244, that is, it will try to set the transmission mode to mode 2. Moreover, when the client logins with mode 2, the server will cancel the original connection of mode 1 and restores all the occupied system resources. Next, the procedure proceeds with step 245 to establish HTTP connection and exchange data packets between the clients and the server (step 246). In step 247, identify whether the proxy server or firewall blocks the connection. If the HTTP connection is not blocked (it means the proxy server or firewall supports persistent connection), the transmission mode will be set to mode 2. Otherwise if the HTTP connection is blocked (it means the proxy server or firewall doesn't support persistent connection), the procedure will try to set the transmission mode to mode 3 (step 249). In addition, it's noticed that the client will automatically start a reconnection mechanism if the client disconnects with server because of artificial reasons or network problems, and then repeat the whole procedure as mentioned above.

Although specific embodiments have been illustrated and described, it will be obvious to those skilled in the art that various modifications may be made without departing from the spirit which is intended to be limited solely by the appended claims.

What is claimed is:

1. A system of automatic transforming instant message transmission modes on Internet, said system comprises:
at least two clients, wherein said client includes a computer system, said computer system comprises a web browser, a first packet-processing program, a network configuration processing program for detecting and identifying a network auto-configuration, a proxy configuration processing program for detecting and identifying a proxy configuration, a connection time-out program, and a Java applet identification program for determining if said client be allowable of downloading and installing a Java applet, and said web browser includes a network auto-configuration and a proxy configuration; and
a server, wherein said server comprises a second packet-processing program for processing a plurality of transmitting packets between said server and said client, a conference management program for opening or closing a network conference and for managing the login and logout of said client, a message broadcast program for transmitting at least a message to said client and for broadcasting said messages to a plurality of clients participating in said network conference, a mode 1 processing program for processing network connection mechanism of the mode 1 and decoding a plurality of packets of the mode 1, a mode 2 processing program for processing network connection mechanism of the mode 2 and decoding a plurality of packets of the mode 2, a mode 3 processing program for processing network connection mechanism of the mode 3 and decoding a plurality of packets of the mode 3, and a mode 4 processing program for processing network connection mechanism of the mode 4 and decoding a plurality of packets of the mode 4;
wherein said mode 1 means a connection that the client connects to the server directly through any allowable socket, said mode 2 means a connection that the client connects to the server across proxy servers and firewalls supporting persistent HTTP 1.1 connection, said mode 3 means a connection that the client connects to the server across proxy servers and firewalls supporting non-persistent HTTP 1.0 connection, and said mode 4 means a connection that a web-based instant interactive message application is applied.

2. The system of claim 1, wherein said client further comprises a proxy server and a firewall for blocking the network connections unallowable of said clients.

3. The system of claim 1, wherein said computer system further comprises a Java run-time environment when the transmission mode is set to said mode 1, said mode 2 or said mode 3, and no plug-in or Java run-time is required when the transmission mode is set to mode 4.

4. The system of claim 2, wherein said proxy server supports HTTP 1.1 or HTTP 1.0 protocol and said firewall supports HTTP 1.1 or HTTP 1.0 protocol.

5. The system of claim 1, wherein said plurality of transmitting packets between said server and said clients are HTTP packets or socket packets.

6. The system of claim 1, wherein said first packet-processing program and said second packet-processing program both are multi-threading Java applications and temporary store the received plurality of transmitting packets between said server and said clients.

7. The system of claim 1, wherein said network configuration processing program is used to identify if said network auto-configuration is assignable and said proxy configuration processing program is used to identify if said proxy configuration is assignable.

8. The system of claim 1, wherein said connection time-out program is used to detect a response time as said client trying to login said server and to identify the numbers of time-out as said client trying to login said server.

9. A method of automatic transforming instant message transmission modes on Internet, said method comprises:
processing a plurality of transmitting packets between a server and at least two clients according to a first packet-processing program and a second packet-processing program, wherein each said clients comprise a computer system, said computer system comprises a web browser, said first packet-processing program, a network configuration processing program, a proxy configuration processing program, a connection time-out program, and a Java applet identification program, wherein said web browser comprises a network auto-configuration and a proxy configuration, and said server comprises said second packet-processing program, a conference management program, a message broadcast program, a mode 1 processing program, a mode 2 processing program, a mode 3 processing program and a mode 4 processing program;
identifying if a Java applet downloadable at said clients;
detecting said network auto-configuration and identifying whether said network auto-configuration is assignable by said network configuration processing program when said Java applet is downloadable at said clients; and
detecting said proxy configuration and identifying whether said proxy configuration is assignable by said proxy configuration processing program when said network auto-configuration is not assignable at said clients;
wherein said mode 1 means a connection that the client connects to the server directly through any allowable socket, said mode 2 means a connection that the client connects to the server across proxy servers and firewalls supporting persistent HTTP 1.1 connection, said mode 3 means a connection that the client connects to the server across proxy servers and firewalls supporting non-persistent HTTP 1.0 connection, and said mode 4 means a connection that a web-based instant interactive message application is applied.

10. The method of claim 9, wherein said mode 4 processing program set the transmission mode to said mode 4 when said Java applet is not downloadable.

11. The method of claim 9 further comprises setting the transmission mode to said mode 2 when said network auto-configuration and said proxy configuration are assignable and setting the transmission mode to the mode 1 when said proxy configuration is not assignable.

12. The method of claim 11 further comprises building up a socket connection and detecting a response time of said socket connection in accordance with said connection time-out program to set the transmission mode to said mode 1 when said response time is less than a pre-defined time, wherein said connection time-out program further detects number of time-out of said socket connection when said response time exceeds said pre-defined time.

13. The method of claim 12 further comprises setting the transmission mode to said mode 2 when said number of time-out exceeds a pre-defined number and detecting said response time of said socket connection by said connection time-out program when said number of time-out is less than a pre-defined number.

14. The method of claim 11 further comprises building up a HTTP connection and exchanging a plurality of HTTP packets between said server and said clients when trying to set the transmission mode to said mode 2.

15. The method of claim 14, wherein the transmission mode is set to said mode 2 by said mode 2 processing program when said HTTP connection is built up with said clients, or the transmission mode is set to said mode 3 by said mode 3 processing program when said HTTP connection is blocked at said clients.

16. The method of claim 9, wherein said computer system further comprises a Java run-time environment when the transmission mode is set to said mode 1, said mode 2 or said mode 3, and no plug-in or Java run-time is required when the transmission mode is set to mode 4.

17. The method of claim 16 further comprises downloading a Java plug-in to said computer system.

18. The method of claim 9, wherein said computer system further comprises a firewall and a proxy server when the transmission mode is set to said mode 2 and said mode 3.

19. The method of claim 18, wherein said proxy server supports HTTP 1.1 or HTTP 1.0 protocol, and said firewall supports HTTP 1.1 or HTTP 1.0 protocol.

20. The method of claim 9, wherein said plurality of transmitting packets between said server and said clients are HTTP packets or socket packets.

21. The method of claim 9, wherein said first packet-processing program and said second packet-processing program both are multi-threading Java applications and temporary store the received plurality of transmitting packets between said server and said clients.

22. The method of claim 9, wherein said conference management program is used to open and close a network conference and be used to manage the login and logout of said clients.

23. The method of claim 9, wherein said message broadcast program is used to transmit at least a message to said clients and broadcast said messages to the clients participating in a network conference.
